(19) United States
(12) Patent Application Publication
(10) Pub. No.: US 2025/0219504 A1
(43) Pub. Date: Jul. 3, 2025

(54) MOTOR AND BLOWER

(71) Applicant: NIDEC CORPORATION, Kyoto (JP)

(72) Inventors: Yoichi SEKII, Kyoto (JP); Kazuhiko FUKUSHIMA, Kyoto (JP)

(21) Appl. No.: 18/991,792

(22) Filed: Dec. 23, 2024

(30) Foreign Application Priority Data
Dec. 28, 2023 (JP) 2023-223402

(51) Int. Cl. H02K 7/08; H02K 7/14

(52) U.S. Cl. CPC H02K 7/085; H02K 7/14

(57) ABSTRACT

A motor includes a rotor rotatable about a central axis extending in an axial direction, a bearing to rotatably support the rotor radially inside, a bearing accommodating portion to accommodate the bearing radially inside, and an annular portion located over at least a portion of the entire region in a circumferential direction. The bearing includes a first groove that is recessed radially inward on an outer peripheral surface and is located over at least a portion of the entire region in the circumferential direction. The bearing accommodating portion includes a second groove that is recessed radially outward on the inner peripheral surface and located over at least a portion of the entire region in the circumferential direction. A portion of the annular portion is accommodated in the first groove. Another portion of the annular portion is accommodated in the second groove.

### CROSS-REFERENCE TO RELATED APPLICATIONS

The present application claims priority under 35 U.S.C. § 119 to Japanese Patent Application No. 2023-223402, filed on Dec. 28, 2023, the entire contents of which are hereby incorporated herein by reference.

### 1. FIELD OF THE INVENTION

The present disclosure relates to motors and blowers.

### 2. BACKGROUND

Conventionally, a motor including a bearing portion that rotatably supports a rotating part and a base portion is known. The bearing portion is fixed to an inner peripheral surface of a rising portion provided to the base portion.

In the motor, the bearing portion is fixed to the rising portion by adhesion. However, in such a fixing method, in a case where an impact is applied to the motor, there is a possibility that damage accumulates in the adhered portion and an adverse effect occurs, so that the bearing portion comes off from the rising portion.

### SUMMARY

An example embodiment of a motor of the present disclosure includes a rotor that is rotatable about a central axis extending in an axial direction, a bearing to rotatably support the rotor radially inside, a bearing accommodating portion to accommodates the bearing radially inside, and an annular portion located over at least a portion of an entire region in a circumferential direction. The bearing includes a first groove that is recessed radially inward on the outer peripheral surface and is located over at least a portion of the entire region in the circumferential direction. The bearing accommodating portion includes a second groove that is recessed radially outward on the inner peripheral surface and located over at least a portion of the entire region in the circumferential direction. A portion of the annular portion is accommodated in the first groove. Another portion of the annular portion is accommodated in the second groove.

An example embodiment of a blower according to the present disclosure includes the motor and a rotor blade rotatable about the central axis together with the rotor of the motor.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a cross-sectional view illustrating a configuration of a blower according to an example embodiment of the present disclosure.

FIG. 2 is an enlarged view of a periphery of a shaft part in FIG. 1.

FIG. 3 is a plan view illustrating an example of an annular portion according to an example embodiment of the present disclosure.

FIG. 4 is a diagram illustrating a first configuration example of a coupling structure between a bearing and a bearing accommodating portion according to an example embodiment of the present disclosure.

FIG. 5 is an enlarged view of a periphery of an annular portion in FIG. 4.

FIG. 6 is a diagram illustrating a first example of an assembling method of the first configuration example of the coupling structure between the bearing and the bearing accommodating portion.

FIG. 7 is a diagram illustrating a second example of an assembling method of the first configuration example of the coupling structure between the bearing and the bearing accommodating portion.

FIG. 8 is a diagram illustrating a second configuration example of a coupling structure between a bearing and a bearing accommodating portion according to an example embodiment of the present disclosure.

FIG. 9 is an enlarged view of a periphery of an annular portion in FIG. 8.

FIG. 10 is a diagram illustrating a third configuration example of a coupling structure between a bearing and a bearing accommodating portion according to an example embodiment of the present disclosure.

FIG. 11 is an enlarged view of a periphery of an annular portion in FIG. 10.

FIG. 12 is a diagram illustrating a fourth configuration example of a coupling structure of a bearing and a bearing accommodating portion according to an example embodiment of the present disclosure.

FIG. 13 is an enlarged view of a periphery of an annular portion in FIG. 12.

FIG. 14A is a diagram illustrating an assembly halfway state of the fourth configuration example of the coupling structure between a bearing and a bearing accommodating portion.

FIG. 14B is a diagram illustrating an assembly halfway state of the fourth configuration example of the coupling structure between the bearing and the bearing accommodating portion.

FIG. 14C is a diagram illustrating an assembly halfway state of the fourth configuration example of the coupling structure between the bearing and the bearing accommodating portion.

FIG. 14D is a diagram illustrating a completed state of assembly of the fourth configuration example of the coupling structure between the bearing and the bearing accommodating portion.

FIG. 15 is an enlarged cross-sectional view illustrating a coupling structure according to a modification of an example embodiment of the present disclosure.

### DETAILED DESCRIPTION

Hereinafter, example embodiments of the present disclosure will be described with reference to the drawings.

In the present specification, in a blower 100 and a motor 101, a direction parallel to a central axis CA is referred to as an “axial direction”. Of the axial directions, a direction from a base portion 3 to a rotor hub 10 described later is referred to as “one axial direction Da”, and a direction from the rotor hub 10 to the base portion 3 is referred to as “the other axial direction Db”. A direction orthogonal to the central axis CA is referred to as a “radial direction”, and a rotation direction about the central axis CA is referred to as a “circumferential direction”. In the radial directions, a direction approaching the central axis CA is referred to as “radially inward Di”, and a direction away from the central axis CA is referred to as “radially outward Do”.

In addition, in a positional relationship between any one of an azimuth, a line, and a plane and another, “parallel” includes not only a state in which both of them do not intersect at all no matter how long they extend, but also a state in which they are substantially parallel. In addition, “perpendicular” and “orthogonal” include not only a state in which both of them intersect each other at 90 degrees, but also a state in which they are substantially perpendicular and a state in which they are substantially orthogonal. That is, the terms “parallel”, “perpendicular”, and “orthogonal” each include a state in which the positional relationship of the both permits an angular deviation to a degree not departing from the gist of the present disclosure.

It is to be noted that the above names are names used merely for description, and are not intended to limit actual positional relationships, directions, names, and the like.

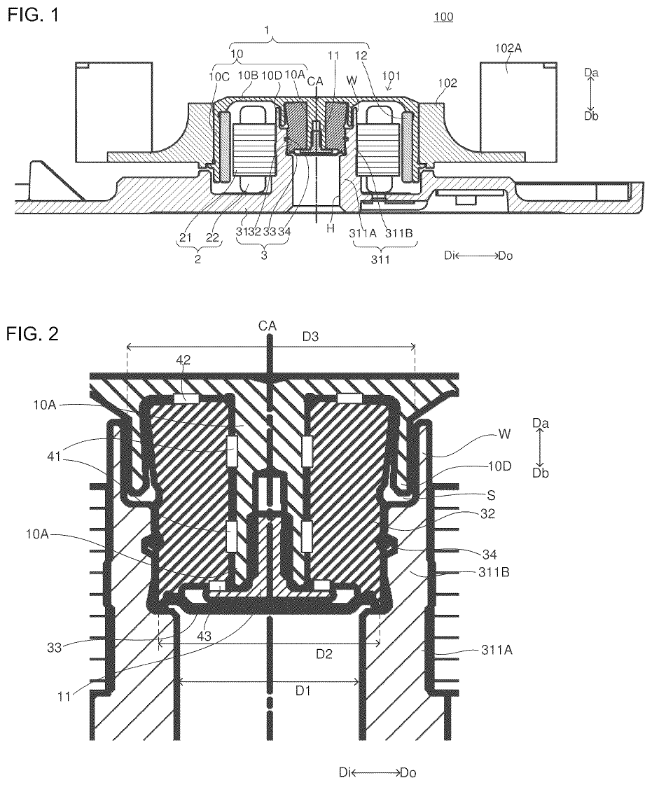

FIG. 1 is a cross-sectional view illustrating a configuration of a blower 100 according to an example embodiment of the present disclosure. The blower 100 of the present example embodiment is an axial fan, and sends out an air flow sucked from one axial direction Da to the other axial direction Db. However, this example does not exclude a configuration in which the blower 100 is other than the axial fan. For example, the blower 100 may be a blower fan or a centrifugal fan.

As shown in FIG. 1, the blower 100 includes a motor 101 and an impeller 102. The impeller 102 includes rotor blades 102A. That is, the blower 100 includes the motor 101 and the rotor blades 102A. The rotor blades 102A are rotatable about the central axis CA together with a rotor 1 of the motor 101 described later. In the present example embodiment, a plurality of rotor blades 102A are disposed radially outside the rotor 1 and aligned in the circumferential direction. When the motor 101 rotates the rotor blades 102A in the circumferential direction, the airflow flows in the axial direction.

The motor 101 includes the rotor 1, a stator 2, and a stationary unit 3. The rotor 1 is rotatable about the central axis CA extending in the axial direction. The rotor 1 includes a rotor hub 10, a retaining portion 11, and a magnet 12.

The rotor hub 10 includes a shaft portion 10A, a disk portion 10B, a wall portion 10C, and a wall portion 10D. The shaft portion 10A extends in the axial direction and is rotatably supported around the central axis CA by a bearing 32 to be described later. The disk portion 10B is a disk-shaped member extending in the radial direction on one side in the axial direction of the shaft portion 10A.

The wall portion 10C extends from the outer peripheral edge portion of the disk portion 10B to the other side in the axial direction and is disposed in the circumferential direction. That is, the wall portion 10C forms a cylinder centered on the central axis CA. An impeller 102 is fixed to the radially outer surface of the wall portion 10C.

The wall portion 10D extends from the disk portion 10B to the other side in the axial direction on the radially inner side of the wall portion 10C, and is disposed in the circumferential direction. That is, the wall portion 10D forms a cylinder centered on the central axis CA.

The retaining portion 11 is fixed to the other axial end of the shaft portion 10A by screwing. The retaining portion 11 is used to prevent the shaft portion 10A from coming out of the bearing 32 to one side in the axial direction.

The magnet 12 is disposed on the radially inner surface of the wall portion 10C, and radially faces the stator 2 (in particular, a stator core 21 to be described later). The magnet 12 is disposed radially outside the stator 2 (particularly the stator core 21) and surrounds the stator 2 (particularly the stator core 21). In the magnet 12, a plurality of different magnetic poles (S pole, N pole) is alternately arranged in the circumferential direction.

The stator 2 rotates the rotor 1 by a magnetic flux generated by energization. As illustrated in FIG. 1, the stator 2 includes the stator core 21, a coil portion 22, and an insulator (not illustrated).

The stator core 21 is an annular magnetic body surrounding the central axis CA, and in the present example embodiment, is a stacked body in which plate-shaped electromagnetic steel plates extending in the radial direction are stacked in the axial direction. The stator core 21 is fixed to the radially outer surface of a stator holder 311 to be described later. Further, the stator core 21 has a slot (not illustrated). A plurality of slots penetrates the stator core 21 in the axial direction and are aligned in the circumferential direction. On the stator core 21, a plurality of the coil portions 22 aligned in the circumferential direction are arranged. The insulator has electrical insulation, and is arranged on a surface of the stator core 21 (particularly, both end surfaces in the axial direction, an inner surface of a slot, and the like).

The coil portion 22 is a member in which a conductive wire is arranged in a coil shape on the stator core 21 with the insulator interposed between them. The conductive wire is, for example, an enamel-coated copper wire, a metal wire coated with an electrically insulating member, or the like, and is wound around a tooth (not illustrated) between slots adjacent to each other in the circumferential direction of the stator core 21 to form the coil portion 22. When the drive current is supplied to each of the coil portions 22, the stator 2 is excited to drive the rotor 1.

The stationary unit 3 includes a base portion 31, the bearing 32, and a cap 33. The base portion 31 includes a stator holder 311 protruding to one side in the axial direction. The stator holder 311 is formed in a cylindrical shape centered on the central axis CA. The stator holder 311 supports the stator 2. A through hole H axially penetrating from the other axial end surface of the base portion 31 to one axial end surface of the stator holder 311 is provided.

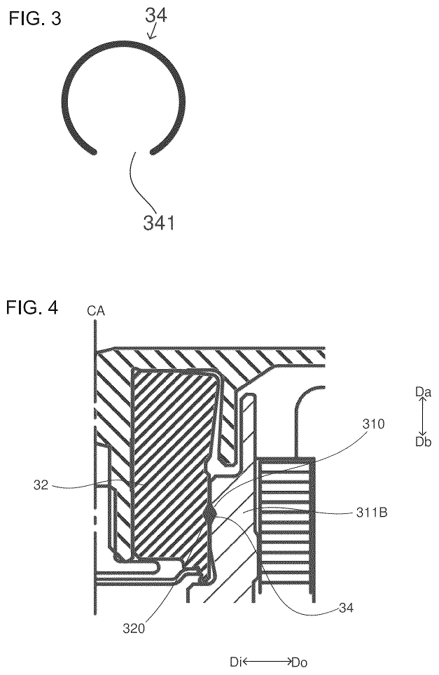

The stator holder 311 has a cylindrical portion 311A on the other farthest side in the axial direction. The stator holder 311 includes a bearing accommodating portion 311B provided on one side in the axial direction of the cylindrical portion 311A. Here, FIG. 2 is an enlarged view of the periphery of the shaft portion 10A in FIG. 1. An inner diameter D1 of the cylindrical portion 311A, an inner diameter D2 of the bearing accommodating portion 311B, and an inner diameter D3 of a wall portion W provided in the bearing accommodating portion 311B, to be described later, have a relationship of D1<D2<D3.

The cap 33 is disposed on the other axial end surface on the radially inner side of the bearing accommodating portion 311B. The bearing 32 has a cylindrical shape extending in the axial direction and centered on the central axis CA, and is configured as a sleeve bearing. The bearing 32 is accommodated radially inside the bearing accommodating portion 311B and is disposed on one side in the axial direction of the cap 33. That is, the motor 101 includes the bearing accommodating portion 311B that accommodates the bearing 32 radially inside. The cap 33 suppresses oil leakage in the bearing 32.

The bearing 32 rotatably supports the shaft portion 10A radially inside. That is, the motor 101 includes the bearing 32 that rotatably supports the rotor 1 radially inside.

As illustrated in FIG. 2, the bearing 32 functions as a radial dynamic pressure bearing. Oil is disposed between the shaft portion 10A and the bearing 32. On at least one of the radially outer surface of the shaft portion 10A and the radially inner surface of the bearing 32, a radial dynamic pressure groove 41 for generating dynamic pressure in the oil interposed therebetween is disposed. The radial dynamic pressure groove 41 is formed in, for example, a herringbone shape. When the shaft portion 10A rotates, the radial dynamic pressure groove 41 generates dynamic pressure in the fluid therebetween. This dynamic pressure separates the bearing 32 and the shaft portion 10A from each other. As a result, the rotating shaft portion 10A is supported in a non-contact state with the bearing 32.

The bearing 32 also functions as a thrust dynamic pressure bearing. Oil is disposed between the disk portion 10B and the bearing 32. On at least one of the other axial side surface of the disk portion 10B and the one axial side surface of the bearing 32, a thrust dynamic pressure groove 42 for generating dynamic pressure in the oil interposed therebetween is disposed. Oil is also disposed between the retaining portion 11 and the bearing 32. On at least one of one axial side surface of the retaining portion 11 and the other axial side surface of the bearing 32, a thrust dynamic pressure groove 43 for generating dynamic pressure in the oil interposed therebetween is disposed.

The thrust dynamic pressure grooves 42 and 43 are formed in, for example, a herringbone shape or a spiral shape. When the shaft portion 10A rotates, the thrust dynamic pressure grooves 42 and 43 generate dynamic pressure in the fluid therebetween. This dynamic pressure separates the bearing 32 from the disk portion 10B and separates the bearing 32 from the retaining portion 11. As a result, the rotating disk portion 10B and the retaining portion 11 are supported in a non-contact state with the bearing 32.

That is, the motor 101 includes at least one of the thrust dynamic pressure grooves 42 and 43 provided at a position where the bearing 32 and the rotor 1 face each other in the axial direction, and the radial dynamic pressure groove 41 provided at a position where the bearing 32 and the rotor 1 face each other in the radial direction. As described later, in the present example embodiment, since the coupling strength between the bearing 32 and the bearing accommodating portion 311B is improved, the bearing 32 and the rotor 1 are prevented from being detached from the bearing accommodating portion 311B due to an impact to cause deformation of the dynamic pressure groove.

As illustrated in FIG. 2, the bearing accommodating portion 311B has the wall portion W at one axial end. The wall portion W has a cylindrical shape centered on the central axis CA and is disposed in the circumferential direction. The wall portion W faces the bearing 32 in the radial direction. The wall portion 10D is accommodated in a gap S extending in the circumferential direction between the bearing 32 and the wall portion W. That is, the rotor 1 has the wall portion 10D disposed in the circumferential direction in the radial gap between the bearing 32 and the wall portion W. The bearing 32, the bearing accommodating portion 311B, and the wall portion W form a labyrinth structure, and oil leakage is suppressed. As will be described later, since the coupling strength between the bearing 32 and the bearing accommodating portion 311B is improved, the axial length of the portion where the bearing 32 is accommodated in the bearing accommodating portion 311B can be shortened, and the labyrinth structure can be easily configured.

Next, a coupling structure between the bearing 32 and the bearing accommodating portion 311B will be described. An annular portion 34 (FIG. 1) is used for coupling the bearing 32 and the bearing accommodating portion 311B. The annular portion 34 is included in the stationary unit 3. That is, the motor 101 includes the annular portion 34. As illustrated in FIG. 3, the annular portion 34 has a cut 341 in a part of the entire region in the circumferential direction. That is, the annular portion 34 is configured as a so-called C ring. As a result, as will be described later, when the coupling structure is assembled, it is easy to attach the annular portion 34 to the bearing 32 or the bearing accommodating portion 311B by widening or narrowing the cut 341.

However, the annular portion 34 may be formed over the entire region in the circumferential direction. That is, the annular portion 34 may be disposed over at least a part of the entire region in the circumferential direction.

FIG. 4 is a diagram illustrating a first configuration example of the coupling structure. As illustrated in FIG. 4, the bearing 32 has a first groove 320 recessed radially inward on the outer peripheral side surface, and the bearing accommodating portion 311B has a second groove 310 recessed radially outward on the inner peripheral side surface. Each of the first groove 320 and the second groove 310 is disposed over the entire region in the circumferential direction. The first groove 320 and the second groove 310 may be disposed over a part of the entire region in the circumferential direction. That is, each of the first groove 320 and the second groove 310 may be disposed over at least a part of the entire region in the circumferential direction.

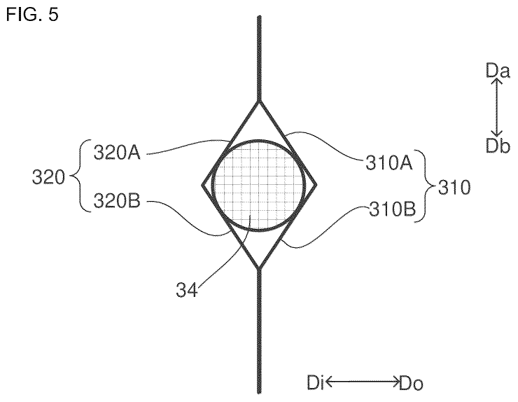

FIG. 5 is an enlarged view of the periphery of the annular portion 34 in FIG. 4. As described in the drawing, the first groove 320 has inclined portions 320A and 320B in the cross-sectional view. The “inclined portion” is inclined with respect to the axial direction. In the inclined portion 320A, the radial depth decreases toward one side in the axial direction, and in the inclined portion 320B, the radial depth decreases toward the other side in the axial direction. The second groove 310 has inclined portions 310A and 310B in a cross-sectional view. In the inclined portion 310A, the radial depth decreases toward one side in the axial direction, and in the inclined portion 310B, the radial depth decreases toward the other side in the axial direction.

As illustrated in FIG. 5, a cross section of the annular portion 34 taken along a section including the central axis CA has a circular shape. A radially inner half of the annular portion 34 is disposed in the first groove 320, and a radially outer half of the annular portion 34 is disposed in the second groove 310. That is, a part of the annular portion 34 is accommodated in the first groove 320, and the other part of the annular portion 34 is accommodated in the second groove 310.

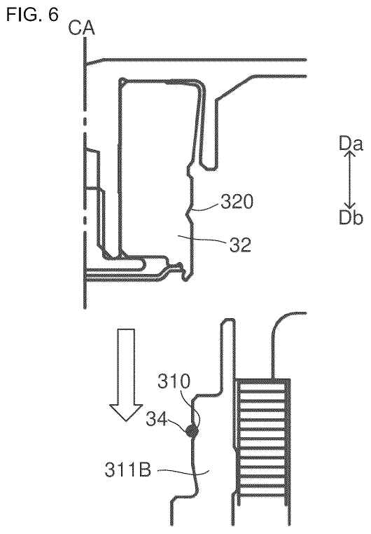

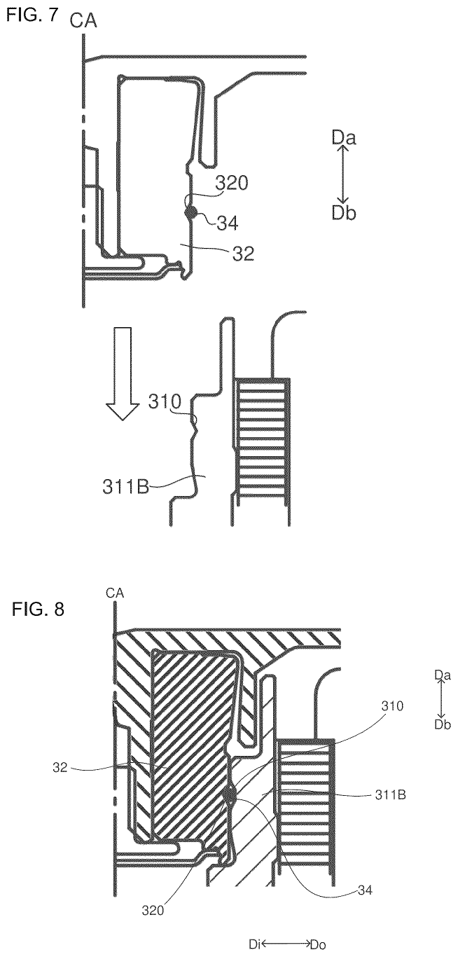

An assembling method of the first configuration example of such a coupling structure will be described with reference to FIGS. 6 and 7. In FIGS. 6 and 7, hatching indicating a cross section is omitted for convenience. FIG. 6 is a diagram illustrating a first example of the assembling method. Here, by narrowing the cut 341 of the annular portion 34, the annular portion 34 is inserted to the radially inner side of the bearing accommodating portion 311B from one side in the axial direction, and the annular portion 34 is accommodated in the second groove 310. At this time, the annular portion 34 is fixed to the second groove 310 by the elastic force. Since the annular portion 34 having a circular shape in a cross-sectional view is positioned in contact with each of the inclined portions 310A and 310B, positioning is easy. Then, as illustrated in FIG. 6, when the bearing 32 is inserted to the radially inner side of the bearing accommodating portion 311B from one side in the axial direction, the annular portion 34 is accommodated in the first groove 320. As a result, the state illustrated in FIG. 5 is obtained, and the assembly is completed. As a result, even if the bearing 32 tries to be removed to one side in the axial direction due to an impact or the like, the inclined portion 320B is caught by the annular portion 34, and thus, the removal of the bearing 32 is suppressed.

FIG. 7 is a diagram illustrating a second example of the assembling method. Here, by widening the cut 341 of the annular portion 34, the annular portion 34 is inserted to the radially outer side of the bearing 32 from the other side in the axial direction, and the annular portion 34 is accommodated in the first groove 320. At this time, the annular portion 34 is fixed to the first groove 320 by the elastic force. Since the annular portion 34 having a circular shape in a cross-sectional view is positioned in contact with each of the inclined portions 320A and 320B, positioning is easy. Then, as illustrated in FIG. 7, when the bearing 32 is inserted to the radially inner side of the bearing accommodating portion 311B from one side in the axial direction, the annular portion 34 is accommodated in the second groove 310. As a result, the state illustrated in FIG. 5 is obtained, and the assembly is completed. As a result, even if the bearing 32 tries to be removed to one side in the axial direction due to an impact or the like, the annular portion 34 is caught by the inclined portion 310A, and thus, the removal of the bearing 32 is suppressed.

As described above, in the present example embodiment, the annular portion 34 and each of the first groove 320 and the second groove 310 are caught, so that the bearing 32 is prevented from coming off in the axial direction. Therefore, the coupling strength between the bearing 32 and the bearing accommodating portion 311B is improved. As described above, since the coupling strength is improved, the rotor blade 102A (FIG. 1) is prevented from being detached from the bearing accommodating portion 311B together with the bearing 32 and the rotor 1.

In addition, since the annular portion 34 has a circular cross section, when the annular portion 34 is accommodated in the second groove 310 as illustrated in FIG. 6 or when the annular portion 34 is accommodated in the first groove 320 as illustrated in FIG. 7, friction is small, so that the annular portion 34 is easily moved. Therefore, the annular portion 34 is easily disposed in the first groove 320 or the second groove 310.

In at least one of the first groove 320 and the second groove 310, the radial depth of the second groove 310 decreases toward one side in the axial direction (inclined portion 310A), and the radial depth of the first groove 320 decreases toward the other side in the axial direction (inclined portion 320B). Since the radial depth of the second groove 310 decreases toward one side in the axial direction, when the annular portion 34 is moved to the second groove 310 for accommodation of the annular portion 34 in the second groove 310 as illustrated in FIG. 6, the annular portion 34 automatically slides in the second groove 310 (inclined portion 310A) and is accommodated in the second groove 310. Similarly, since the radial depth of the first groove 320 decreases toward the other side in the axial direction, when the annular portion 34 is moved to the first groove 320 for accommodation of the annular portion 34 in the first groove 320 as illustrated in FIG. 7, the annular portion 34 automatically slides in the first groove 320 (inclined portion 320B) and is accommodated in the first groove 320. Therefore, the annular portion 34 is easily disposed in the first groove 320 or the second groove 310. Further, deformation of the first groove 320 or the second groove 310 due to an impact is suppressed.

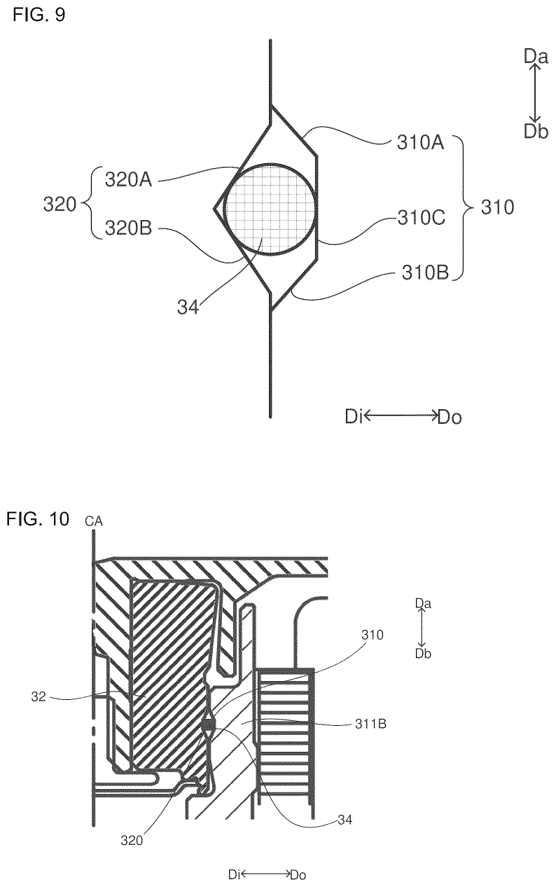

FIG. 8 is a diagram illustrating a second configuration example of the coupling structure. FIG. 9 is an enlarged view of the periphery of the annular portion 34 in FIG. 8. As described in the drawing, the first groove 320 has the inclined portions 320A and 320B in the cross-sectional view similarly to the first configuration example described above. On the other hand, unlike the first configuration example described above, the second groove 310 has an axial portion 310C in addition to the inclined portions 310A and 310B in the cross-sectional view. The axial portion 310C extends along the axial direction. One axial end of the axial portion 310C is connected to the other axial end of the inclined portion 310A. The other axial end of the axial portion 310C is connected to one axial end of the inclined portion 310B. The one axial end of the inclined portion 310A is located on one axial side with respect to the one axial end of the inclined portion 320A. The other axial end of the inclined portion 310B is located on the other axial side with respect to the other axial end of the inclined portion 320B. Thus, the axial length of the axial portion 310C is secured to be long. In the axial portion 310C, the radial depth is constant in the axial direction.

The annular portion 34 is fixed to the axial portion 310C by the elastic force. As a result, the inclined portion 320B is caught by the annular portion 34, so that the bearing 32 is prevented from coming off to one side in the axial direction. Further, in the present configuration example, as illustrated in FIG. 9, the first groove 320 includes the inclined portions 320A and 320B, and the second groove 310 includes the axial portion 310C in addition to the inclined portions 310A and 310B. If both the first groove 320 and the second groove 310 are configured of the inclined portions 320A and 320B as in the first configuration example (FIG. 5) described above, both the first groove 320 and the second groove 310 have a configuration focusing on positioning, but there is a possibility that positioning effects interfere with each other. Therefore, in the present configuration example, by providing the axial portion 310C in the second groove 310, the movement of the annular portion 34 is allowed to some extent, so that the assembly can be facilitated. In particular, since the axial length of the axial portion 310C is secured to be long as described above, the effect of the above-described movement allowance is increased.

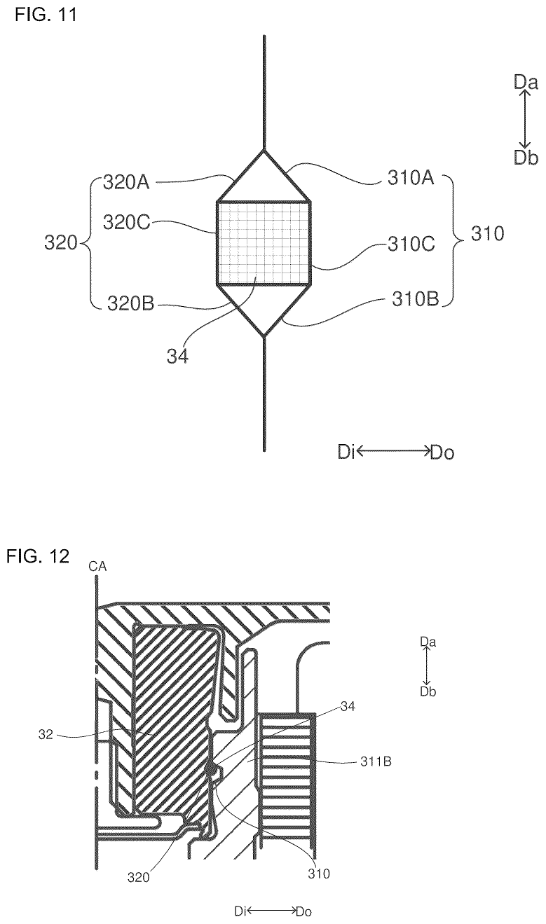

FIG. 10 is a diagram illustrating a third configuration example of the coupling structure. FIG. 11 is an enlarged view of the periphery of the annular portion 34 in FIG. 10. As described in the drawing, the second groove 310 has the inclined portions 310A and 310B and the axial portion 310C in the cross-sectional view similarly to the second configuration example described above. On the other hand, unlike the second configuration example, the first groove 320 has an axial portion 320C in addition to the inclined portions 320A and 320B in the cross-sectional view. One axial ends of the inclined portion 320A and the inclined portion 310A match, and the other axial ends of the inclined portion 320B and the inclined portion 310B match.

The annular portion 34 is different from those of the first and second configuration examples. Specifically, a cross section of the annular portion 34 taken along a section including the central axis CA has a rectangular shape. One radially inner side of the annular portion 34 is in contact with the axial portion 320C, and one radially outer side of the annular portion 34 is in contact with the axial portion 310C. As a result, the contact area between the annular portion 34 and the first groove 320 or the second groove 310 increases, so that the coupling strength between the bearing 32 and the bearing accommodating portion 311B is further improved.

The annular portion 34 is fixed to one of the axial portions 320C and 310C by the elastic force. As a result, the annular portion 34 is caught by the inclined portion 310A or the inclined portion 320B is caught by the annular portion 34, so that the bearing 32 is prevented from coming off to the one side in the axial direction.

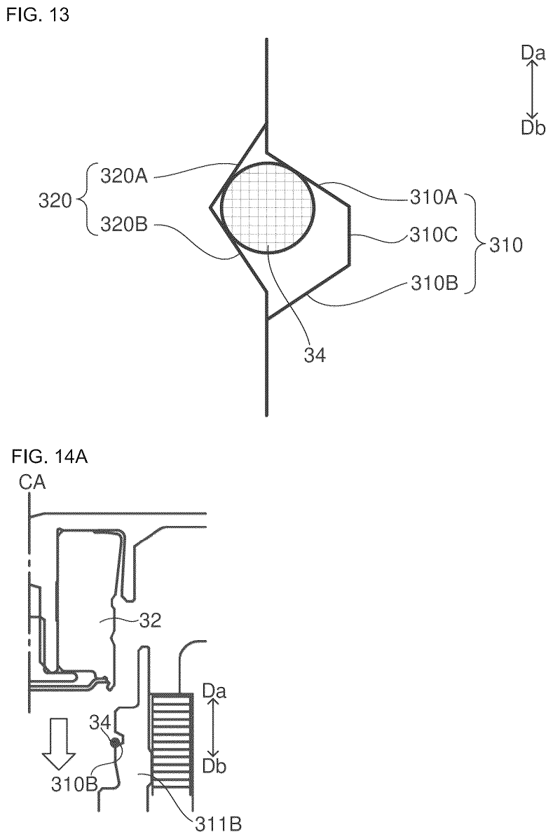

FIG. 12 is a diagram illustrating a fourth configuration example of the coupling structure. FIG. 13 is an enlarged view of the periphery of the annular portion 34 in FIG. 12. The annular portion 34 has a circular shape in a cross-sectional view. The first groove 320 has inclined portions 320A and 320B in a cross-sectional view. The second groove 310 has inclined portions 310A and 310B and an axial portion 310C in a cross-sectional view. One axial end of the inclined portion 310A is located on the other axial side with respect to one axial end of the inclined portion 320A. The other axial end of the inclined portion 310B is located on the other axial side with respect to the other axial end of the inclined portion 320B.

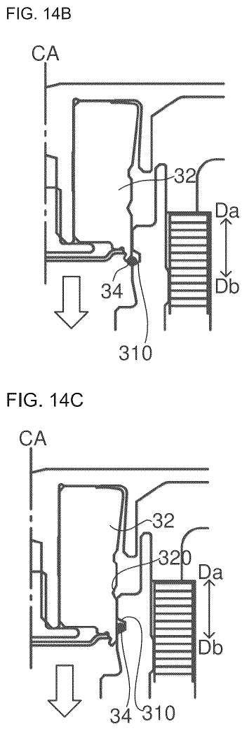

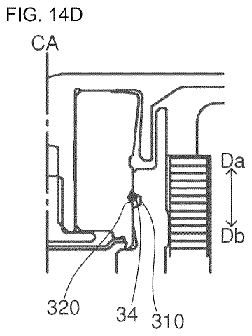

An assembling method of the fourth configuration example will be described with reference to FIGS. 14A to 14D. In FIGS. 14A to 14D, hatching indicating a cross section is omitted for convenience. First, as illustrated in FIG. 14A, the annular portion 34 is inserted to the radially inner side of the bearing accommodating portion 311B from one side in the axial direction, and the annular portion 34 is accommodated in the second groove 310. At this time, as illustrated in FIG. 14A, the annular portion 34 is disposed in contact with the inclined portion 310B in the natural length state.

Then, the bearing 32 is inserted to the radially inner side of the bearing accommodating portion 311B from one side in the axial direction. Then, as illustrated in FIG. 14B, the radially outer surface of the other axial end of the bearing 32 comes into contact with the annular portion 34. When the insertion of the bearing 32 is further advanced, as illustrated in FIG. 14 C, the annular portion 34 extends radially outward, and the annular portion 34 is disposed between the radially outer surface of the bearing 32 and the second groove 310. When the insertion of the bearing 32 is further advanced, the first groove 320 overlaps the second groove 310, and finally the state illustrated in FIG. 14D is obtained. Here, as illustrated in FIG. 13 specifically, the annular portion 34 comes into contact with the inclined portions 320A and 320B and the inclined portion 310A in the natural length state, and the annular portion 34 is pressed against the bearing 32 by the inclined portion 310A. As a result, the annular portion 34 is caught by the inclined portion 310A, so that the bearing 32 is prevented from coming off to one side in the axial direction. In particular, since the inclined portions 310A and 320B sandwich the annular portion 34, the inclined portion 310A functions as a wall that suppresses coming off when the bearing 32 tries to come off to one side in the axial direction.

In the first to fourth configuration examples, at least a part of the first groove 320 and at least a part of the second groove 310 overlap each other in the axial direction. As a result, the axial thickness of the annular portion 34 decreases, and the annular portion 34 can be downsized. However, the present disclosure is not limited thereto, and the first groove 320 and the second groove 310 may not overlap each other in the axial direction. That is, the entire axial region of the first groove 320 and the entire axial region of the second groove 310 may be shifted in the axial direction.

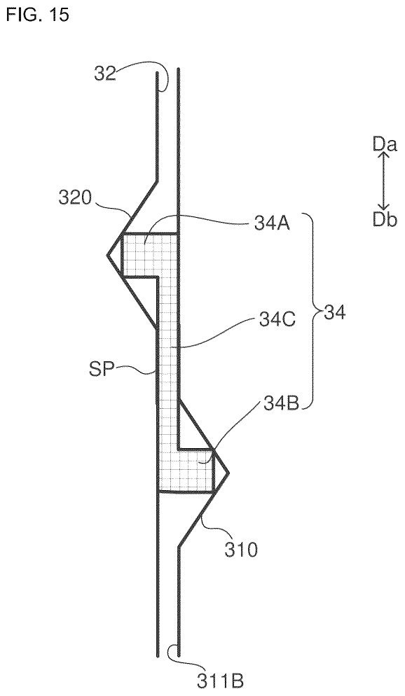

FIG. 15 illustrates a configuration according to such a modification. FIG. 15 is an enlarged view illustrating a cross-sectional configuration around the annular portion 34. As described in the drawing, the first groove 320 and the second groove 310 do not overlap in the axial direction. The annular portion 34 includes annular portions 34A and 34B and a connecting portion 34C. The annular portion 34A is disposed at one axial end of the annular portion 34 and is disposed in the circumferential direction around the central axis CA. The annular portion 34B is disposed at the other axial end of the annular portion 34 and is disposed in the circumferential direction around the central axis CA. The connecting portion 34C axially connects the radially outer end of the annular portion 34A and the radially inner end of the annular portion 34B. The annular portion 34A is accommodated in the first groove 320, and the annular portion 34B is accommodated in the second groove 310. The connecting portion 34C is disposed in a gap SP between the radially outer surface of the bearing 32 and the radially inner surface of the bearing accommodating portion 311B.

The example embodiments of the present disclosure have been described above. Note that the scope of the present disclosure is not limited to the above example embodiments. The present disclosure can be implemented by making various changes to the above example embodiments without departing from the gist of the disclosure. The matters described in the above example embodiments can be optionally combined together, as appropriate, as long as there is no inconsistency.

As described above, a motor according to an example embodiment of the present disclosure includes a rotor rotatable about a central axis extending in an axial direction, a bearing to rotatably support the rotor radially inside, a bearing accommodating portion to accommodate the bearing radially inside, and an annular portion located over at least a portion of an entire region in a circumferential direction, wherein the bearing includes a first groove that is recessed radially inward on an outer peripheral surface and is located over at least a portion of an entire region in the circumferential direction, the bearing accommodating portion includes a second groove that is recessed radially outward on an inner peripheral surface and is located over at least a portion of an entire region in the circumferential direction, a portion of the annular portion is accommodated in the first groove, and another portion of the annular portion is accommodated in the second groove (first configuration).

In the first configuration, at least a portion of the first groove and at least a portion of the second groove may overlap each other in the axial direction (second configuration).

In the first or second configuration, the annular portion may include a cut in a portion of the entire region in the circumferential direction (third configuration).

In any one of the first to third configurations, in at least one of the first groove and the second groove, a radial depth of the second groove may decrease toward one side in the axial direction, and a radial depth of the first groove may decrease toward the other side in the axial direction (fourth configuration)

In any one of the first to fourth configurations, a cross section of the annular portion taken along a section including the central axis may have a circular shape (fifth configuration).

In any one of the first to fourth configurations, a cross section of the annular portion taken along a section including the central axis may have a rectangular shape (sixth configuration).

In any one of the first to sixth configurations, the bearing accommodating portion may include a first wall located in the circumferential direction to oppose the bearing in the radial direction at an end on one side in the axial direction, and the rotor may include a second wall portion located in the circumferential direction in a radial gap between the bearing and the first wall portion (seventh configuration).

In any one of the first to seventh configurations, the motor may include at least one of a thrust dynamic pressure groove provided at a position where the bearing and the rotor oppose each other in the axial direction and a radial dynamic pressure groove provided at a position where the bearing and the rotor oppose each other in the radial direction (eighth configuration).

A blower according to an example embodiment of the present disclosure includes the motor having any one of the first to eighth configurations, and a rotor blade rotatable about the central axis together with the rotor of the motor (ninth configuration).

Example embodiments of the present disclosure can be used for, for example, a blower for various purposes.

Features of the above-described example embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A motor comprising:
a rotor rotatable about a central axis extending in an axial direction;
a bearing to rotatably support the rotor radially inside;
a bearing accommodating portion to accommodate the bearing radially inside; and
an annular portion located over at least a portion of an entire region in a circumferential direction; wherein
the bearing includes a first groove that is recessed radially inward on an outer peripheral surface and is located over at least a portion of an entire region in the circumferential direction;
the bearing accommodating portion includes a second groove that is recessed radially outward on an inner peripheral surface and is located over at least a portion of an entire region in the circumferential direction;
a portion of the annular portion is accommodated in the first groove; and
another portion of the annular portion is accommodated in the second groove.

2. The motor according to claim 1, wherein at least a portion of the first groove and at least a portion of the second groove overlap each other in the axial direction.

3. The motor according to claim 1, wherein the annular portion includes a cut in a portion of the entire region in the circumferential direction.

4. The motor according to claim 1, wherein, in at least one of the first groove and the second groove, a radial depth of the second groove decreases toward one side in the axial direction, and a radial depth of the first groove decreases toward another side in the axial direction.

5. The motor according to claim 1, wherein a cross section of the annular portion taken along a section including the central axis has a circular or substantially circular shape.

6. The motor according to claim 1, wherein a cross section of the annular portion taken along a section including the central axis has a rectangular or substantially rectangular shape.

7. The motor according to claim 1, wherein
the bearing accommodating portion includes a first wall portion located in the circumferential direction to oppose the bearing in a radial direction at an end on one side in the axial direction; and
the rotor includes a second wall portion located in the circumferential direction in a radial gap between the bearing and the first wall portion.

8. The motor according to claim 1, further comprising at least one of a thrust dynamic pressure groove provided at a position where the bearing and the rotor oppose each other in the axial direction, and a radial dynamic pressure groove provided at a position where the bearing and the rotor oppose each other in the radial direction.

9. A blower comprising:
the motor according to claim 1; and
a rotor blade rotatable about the central axis together with the rotor of the motor.
